(19) United States
(12) Patent Application Publication
(10) Pub. No.: US 2009/0268222 A1
(43) Pub. Date: Oct. 29, 2009

(54) PRINTING SYSTEM AND INFORMATION PROCESSING SYSTEM

(75) Inventor: Yuichi USHIKUBO, Fukushima-shi (JP)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: Oki Data Corporation, Tokyo (JP)

(21) Appl. No.: 12/428,070

(22) Filed: Apr. 22, 2009

(30) Foreign Application Priority Data
Apr. 23, 2008 (JP) 2008-112573

(51) Int. Cl. G06F 3/12

(52) U.S. Cl. 358/1.13

(57) ABSTRACT

In a printing system, a first image processing apparatus includes an installer for installing a driver to drive an image forming apparatus; and a second image processing apparatus in which the driver is incorporated, in the installer, a search request section outputs a search request representing whether the driver has been installed to the second processing apparatus; a driver setting information obtaining section outputs a sending request of the driver setting information to the second image processing apparatus after received a reply information from the second image processing apparatus with respect to the search request; and an installing section installs the driver on the basis of the driver setting information, in the second image processing apparatus, a first sending section generates and sends reply information to reply to search request; and a second sending section generates and sends driver setting information to reply to send request.

### BACKGROUND OF THE INVENTION

1. Field of the Invention

The invention relates to a printing system in which an image processing apparatus is connected with an image forming apparatus through network and the image processing apparatus outputs print request of an image to the image forming apparatus; and relates to an information processing system in which first information process apparatus and second information process apparatus are connected through network.

2. Related Background Art

Until now, a personal computer (hereinafter: PC), as an image processing apparatus to constitute a printing system, performs an installation of printer driver that is stored in floppy disc or CD (Compact Disc), or is supplied from network, by executing driver installer that is formed through using set driver setting information in which inherence information is set as initial value. Then, the PC installs the printer driver through using driver installer.

In the driver setting information, there are plural setting value information used for prescribing print condition such as resolution of printing, existence/inexistence of toner save, color designation of printing in color or printing in monochrome, and the like; option information that is formed from information to set print function for using additional apparatus about existence/inexistence of duplex print, existence/inexistence of second tray and the like; and IP address that is allotted to printer to execute print; and the like. In the past, when printer driver is installed, the setting value information, the option information and the IP address are set according to driver setting information in which an initial value was set, further, regarding some settings adjusting to use environment of user, it is necessary to be set through user inputs in installing of driver or after installed.

Furthermore, in a patent document 1 mentioned below, a printer control system is disclosed that searches a predetermined printer driver in network and installs it.

Patent document 1: Japan patent publication Hei11-134135.

### SUMMARY OF THE INVENTION

A first aspect of the invention is to provide a printing system, which comprises a first image processing apparatus that includes an installer for installing a driver to drive an image forming apparatus, and installs the driver; and a second image processing apparatus in which the driver is incorporated, wherein the first image processing apparatus is connected with the second image processing apparatus through network, the installer included in the first image processing apparatus has a search request section that outputs a search request representing whether or not the driver has been installed to the second processing apparatus through the network; a driver setting information obtaining section that, after received a reply information from the second image processing apparatus with respect to the search request, outputs a sending request of the driver setting information with respect to the second image processing apparatus; and an installing section that installs the driver on the basis of the driver setting information that was obtained from the driver setting information obtaining section, wherein the second image processing apparatus includes a first sending section that generates and sends reply information to reply to search request of the search request section; and a second sending section that generates and sends driver setting information to reply to send request of the driver setting information obtaining section.

A second aspect of the invention is to provide an information processing system, which comprises a first information processing apparatus that includes an installer for installing a driver to operate an external apparatus, and installs the driver; and a second information processing apparatus in which the driver is incorporated, wherein the first information processing apparatus is connected with the second information processing apparatus through network, the installer included in the first information processing apparatus has a search request section that outputs a search request representing whether or not the driver has been installed to the second information processing apparatus through the network; a driver setting information obtaining section that, after received a reply information from the second information processing apparatus with respect to the search request, outputs a sending request of the driver setting information with respect to the second information processing apparatus; and an installing section that installs the driver on the basis of the driver setting information that was obtained by the driver setting information obtaining section, wherein the second information processing apparatus includes a first sending section that generates and sends reply information to reply to search request of the search request section; and a second sending section that generates and sends driver setting information to reply to send request of the driver setting information obtaining section.

### EFFECT OF THE PRESENT INVENTION

According to the invention, when printer driver is installed in an information processing apparatus, because driver setting information obtaining section obtains driver setting information from another information processing apparatus that sent reply information, and then the driver setting information is set, so it is unnecessary to input through user, so that time of setting work of driver can be shortened.

The above and other objects and features of the present invention will become apparent from the following detailed description and the appended claims with reference to the accompanying drawings.

### BRIEF DESCRIPTION OF THE DRAWINGS

FIG. 1 is a block diagram showing a structure of a PC to install a printer driver in a printing system and showing a structure of a driver installer that was expanded in the PC, in embodiment 1;

FIG. 2 is a block diagram showing a structure of a printing system in embodiment 1;

FIG. 3 is a diagram showing a structure of search packet generation use table in FIG. 1;

FIG. 4A is a diagram showing a structure of search packet;

FIG. 4B is a diagram showing a structure of reply packet;

FIG. 5 is a diagram showing a structure of IP packet header part in FIG. 4;

FIG. 6 is a diagram showing an example of driver setting information obtaining scene;

FIG. 7 is a diagram showing an example of driver setting information displaying scene;

FIG. 8 is a block diagram showing a structure of a PC in which printer driver in FIG. 2 is installed;

FIG. 9 is a flow chart for explaining operation of PC that inputs driver setting information in printing system of embodiment 1;

FIG. 10 is a flow chart for explaining operation of PC that sends driver setting information through FTP in printing system of embodiment 1;

FIG. 11 is a block diagram showing a structure of a printing system in embodiment 2;

FIG. 12 is a block diagram showing a structure of a PC in a printing system to install a printer driver and showing a structure of a driver installer that was expanded in the PC, in embodiment 2;

FIG. 13 is a diagram showing an example of search result list displaying scene;

FIG. 14 is a first flow chart for explaining operation of PC that inputs driver setting information in printing system of embodiment 2;

FIG. 15 is a second flow chart for explaining operation of PC that inputs driver setting information in printing system of embodiment 2; and

FIG. 16 is a block diagram showing a structure of # iPC and # nPC in which printer driver is installed.

### DETAILED DESCRIPTION OF THE PREFERRED EMBODIMENTS

Embodiments of the invention will be described in detail hereinbelow with reference to the drawings.

### Embodiment 1

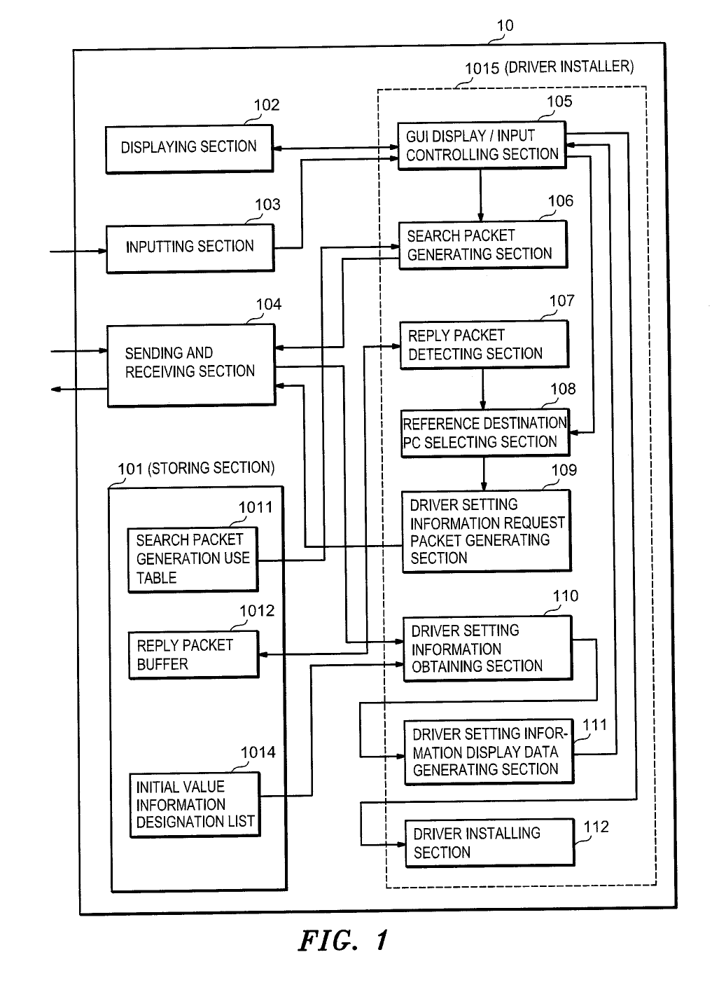

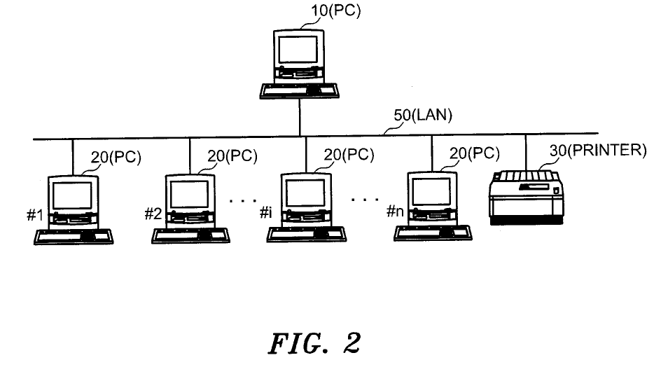

FIG. 1 is a block diagram showing a structure of a PC to install a printer driver in a printing system and showing a structure of a driver installer 1015 that was expanded in the PC, in embodiment 1. FIG. 2 is a block diagram showing a structure of a printing system in embodiment 1. As shown by FIG. 2, a printing system of embodiment 1 comprises a structure in which a personal computer 10 (hereinafter: PC) that is a first information processing apparatus or a first image processing apparatus for installing printer driver, personal computers 20 that are represented by # 1˜# n (hereinafter: PCs of # 1˜# n), and each PC 20 is a second information processing apparatus or a second image processing apparatus; and a printer 30 that serves as an external apparatus or an image forming apparatus, are connected through a LAN (Local Area Network) 50 that serves as a network.

The PC 10, as shown by FIG. 1, comprises a storing section 101, a displaying section 102, an inputting section 103, a sending and receiving section 104, a GUI display/input controlling section 105, a search packet generating section 106, a reply packet detecting section 107, a reference destination PC selecting section 108, a driver setting information request packet generating section 109, a driver setting information obtaining section 110, a driver setting information display data generating section 111 and a driver installing section 112. The GUI display/input controlling section 105, the search packet generating section 106, the reply packet detecting section 107, the reference destination PC selecting section 108, the driver setting information request packet generating section 109, the driver setting information obtaining section 110, the driver setting information display data generating section 111 and the driver installing section 112 constitute a driver installer 1015.

The respective GUI (Graphical User Interface) display/input controlling section 105, search packet generating section 106, reply packet detecting section 107, reference destination PC selecting section 108, driver setting information request packet generating section 109, driver setting information display data generating section 111 and driver installing section 112 are generated in a second storing section of control use (not shown) through CPU (not shown) that executes the driver installer 1015. The driver installer 1015 is stored in floppy disc and CD, or is software for installing printer driver that is supplied from network to hard disc apparatus (not shown). The sending and receiving section 104 has a function of performing sending and receiving of packet. Moreover, regarding the packet, it may be signal string obtained by digitalizing information and dividing the digitalized information into predetermined length.

A first storing section 101 of information use is composed of RAM, ROM, flash memory and hard disc apparatus (not shown), has a search packet generation use table 1011 and a reply packet buffer 1012, stores a initial value information designation list 1014 and control program (not shown).

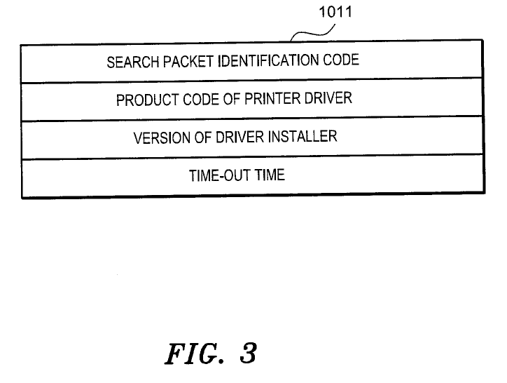

The search packet generation use table 1011 is formed in a first storing section 101 that is a non-volatility memory such as flash memory or the like incapable of being rewrote. In the search packet generation use table 1011, information is set that becomes necessary for generating search packet for searching the PC 20 in which printer driver is installed. In the information for generating the search packet, as shown by FIG. 3, search packet identification code, product code of printer driver, version of driver installer 1015 and time-out period are contained.

The search packet identification code is code to judge whether or not IP packet that is sent is search packet through the LAN 50 in PCs 20 of # 1˜# n that received the IP packet. The product code of printer driver is code that identifies product of printer driver to execute printing in the printer 30. The version of driver installer 1015 is version of the driver installer 1015 that holds the driver installer 1015 that is stored in the storing section 101. The time-out period represents time that it is possible to detect reply packet that can be sent from PCs of # 1 ˜# n.

The reply packet buffer 1012 is formed in RAM (not shown), is formed through the search packet generating section 106, and stores reply packet that can be sent from PCs 20 of # 1˜# n with respect to the broadcasting search packet in the LAN 50.

In the initial value information designation list 1014, driver setting information that is used as initial value in the case that the driver setting information from the PC can be not received is stored. For example, initial value of the resolution in printing time, the existence/inexistence of toner save, the print condition of color designation of printing in color or printing in monochrome, and the like are previously stored.

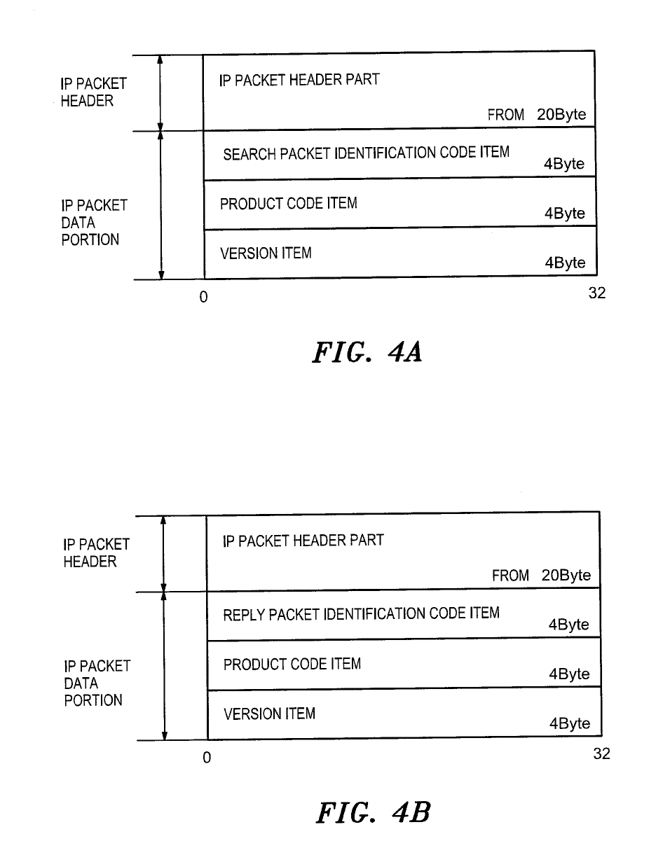

The search packet, as shown by FIG. 4A in header part, comprises an IP packet header part, a search packet identification code item, a product code item and a version item.

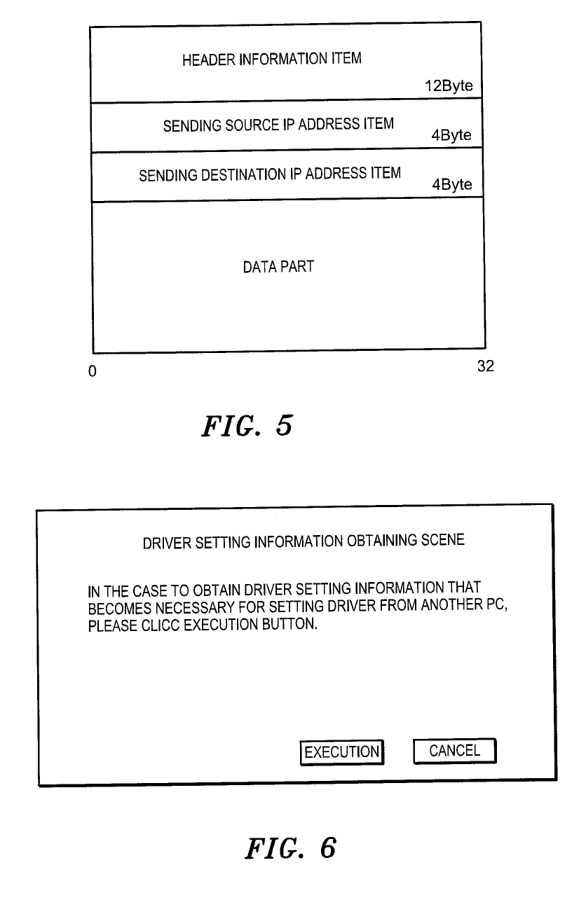

In the IP packet header part, as shown by FIG. 5, a header information item, a sending source IP address item, a sending destination IP address item and a data section are included.

In the header information item, in network layer that is applied in OSI (Open System Interconnection), information that is necessary in the case to perform communication mutually such as version number, header length displaying, service type and IP packet length and the like, is recorded.

In the sending source IP address item, IP address that is allotted to self-apparatus is recorded. In the sending destination IP address item, broadcast address for broadcasting (for sending simultaneously) in the LAN 50 is recorded.

The reply packet, as shown by FIG. 4B in header part, comprises an IP packet header part, a search packet identification code item, a product code item and a version item.

In the IP packet header part, as shown by FIG. 5, a header information item, a sending source IP address item, a sending destination IP address item and a data section are included.

In the header information item, the information stated above such as version number, header length displaying, service type and IP packet length and the like, is recorded. In the sending source IP address item, IP address that is allotted to PC 20 that sent the reply packet is recorded. In the sending destination IP address item, IP address that is allotted to PC 10 that sent reply packet is recorded

The displaying section 102 shown by FIG. 1, in the present embodiment, for example, is formed from LCD displaying apparatus, displays status information of apparatus itself, and displays a displaying scene to execute processing that is requested by user. As the displaying scene, in the present embodiment, there is a driver setting information obtaining scene shown by FIG. 4 that becomes necessary when driver setting information is obtained from another PC 20.

The inputting section 103 is formed from pointing device such as keyboard, for example, is used for clicking “execution” button, “cancel” or “OK” button that are displayed on the driver setting information obtaining scene stated above.

The sending and receiving section 104 sends search packet to the PCs 20 of # 1˜# n through the LAN 50, and receives reply packet from the PCs 20 of # 1˜# n. Further, the sending and receiving section 104 sends driver setting information request packet that was inputted from the driver setting information request packet generating section 109 to the PC 20. Further, the sending and receiving section 104 receives the driver setting information IP packet in which the driver setting information is recorded from the PC 20, and then stores it in RAM.

The GUI display/input controlling section 105, after the driver installer 1015 is executed, makes the displaying section 102 display the driver setting information obtaining scene shown by FIG. 6. Further, the GUI display/input controlling section 105, after the execution button that is displayed on the driver setting information obtaining scene by user is clicked, outputs execution information to the reference destination PC selecting section 108.

The search packet generating section 106, as a search request section, reads out the search packet identification code, the product code of printer driver, the version of driver installer 1015 and the time-out period from the search packet generation use table 1011 shown by FIG. 3. Then, the search packet generating section 106, as shown by FIG. 5, records header information in the header information item of the IP packet header part; furthermore, as shown by FIG. 4A, records the search packet identification code that was read out in the search packet identification code item of the data section; next, records the product code of the printer driver that was read out in the product code item; furthermore, records the version of the driver installer 1015 that was read out in the version item; and then generates search packet. Then, the search packet generating section 106 outputs the search packet that was generated to the sending and receiving section 104.

Further, the search packet generating section 106, after outputted the search packet to the sending and receiving section 104, makes timer (not shown) measure time-out period that was read out.

The reply packet detecting section 107, when it is judged that the timer is watched and the timer is time-out, makes the reference destination PC selecting section 108 shift main body of control. Further, the reply packet detecting section 107, when receiving reply packet in time-out period, stores the reply packet in the reply packet buffer 1012 of the storing section 101.

The reference destination PC selecting section 108, when only one reply packet is stored in the reply packet buffer 1012, selects an IP address that is recorded in the sending source IP address item of the reply packet as an IP address of the PC 20 that sends driver setting information, and temporarily stores it in RAM.

The reference destination PC selecting section 108, when plural reply packets are stored in the reply packet buffer 1012, selects an IP address that is recorded in the sending source IP address item of the reply packet that is stored in the firstly received reply packet, that is, in the place that the address of the reply packet buffer 1012 is the smallest as an IP address of the PC 20 that sends driver setting information, and temporarily stores the IP address in RAM.

In the embodiment, the reason of selecting the IP address that is recorded in the firstly received reply packet, when plural reply packets are received, is that time can be expected to be shortened, further, is that processing that selects any of reply packets is omitted. Further, the selection of the IP address is well when being decided suitably, for example, it may be decided according to communication speed during the PC 20 sends the reply packet.

The driver setting information request packet generating section 109 reads out the IP address stated above that is stored in RAM, with respect to the PC 20 to which the IP address is allotted, after the setting information request packet for obtaining the driver setting information is generated by using FTP (File Transfer Protocol), outputs these driver setting information in the RAM. Here, the search packet generating section 106 and the driver setting information request packet generating section 109 are a generating section to generate packet containing information that was requested through the sending and receiving section 104 upon respective conditions in driver installing; and are a sending section to send the generated information. In other words, when respective generating sections are two sending sections in which the search packet generating section 106 is regarded as the first sending section and the driver setting information request packet generating section 109 is regarded as the second sending section, and different information is requested in the driver installer 1015 through the sending and receiving section 104, it is possible to use sending sections corresponding to respective requests, so as to send information, i.e. packet corresponding to respective requests.

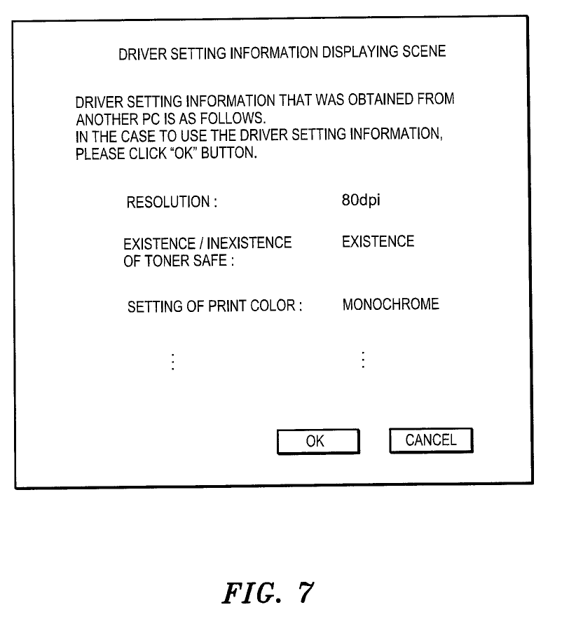

The driver setting information obtaining section 110, after the information representing that received the driver setting information from the sending and receiving section 104, reads out respective driver setting information that is stored in the RAM, generates display data to display the driver setting information displaying scene shown by FIG. 7, and then outputs the display data to the GUI display/input controlling section 105. On the driver setting information displaying scene, when user selects “OK”, the driver setting information is used, and when user selects “cancel”, the driver setting information that is stored in the initial value information designation list 1014 is used.

The driver installing section 112 reads out the driver setting information from the RAM, regards such as the driver setting information, the IP address of the printer 30 and the option information and the like as driver setting information, in the present embodiment, for example, installs the printer driver that is stored in CD-ROM.

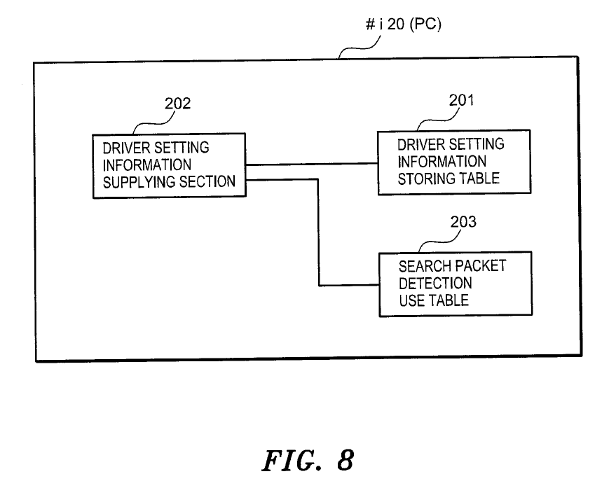

For example, the PC 20 of # 1 (the PC 10 installs the driver that should be installed) that is shown by FIG. 2, as shown by FIG. 8, includes a driver setting information storing table 201, a driver setting information supplying section 202 and a search packet detection use table 203. Here, the driver setting information supplying section 202 is formed through executing control program that is stored in ROM (not shown) by the CPU (not shown).

The driver setting information storing table 201 is formed from flash memory, stores the driver setting information of the printer driver that has already been registered.

The driver setting information supplying section 202, when permanently stationing in OS (Operating System), and receiving search packet that was sent from the PC 10 through the LAN 50, reads out search packet identification code, product code and version of driver installer 1015 from respective search packet identification code item, product code item and version item of the search packet. Then, the driver setting information supplying section 202, refers to the search packet detection use table 203, and then judges whether or not the search packet identification code and the product code of the printer driver that were read out have been registered together with the search packet detection use table 203.

Further, the driver setting information supplying section 202, when it is judged that the search packet identification code and the product code that were read out have been registered together with the search packet detection use table 203, generates reply packet that is shown by FIG. 4B, and sends the reply packet to the PC 10 through the LAN 50.

The search packet detection use table 203 stores information for judging whether or not the IP packet that has been sent is search packet, and information for generating reply packet. The information for judging whether or not the IP packet is search packet is the search packet identification code and the product code of the printer driver that were stated above. The information for generating reply packet is the reply packet identification code, the product code of the printer driver, the version of the printer driver and the IP address of the printer 30.

Next, it is to explain operation of printing system of embodiment 1 in the present invention.

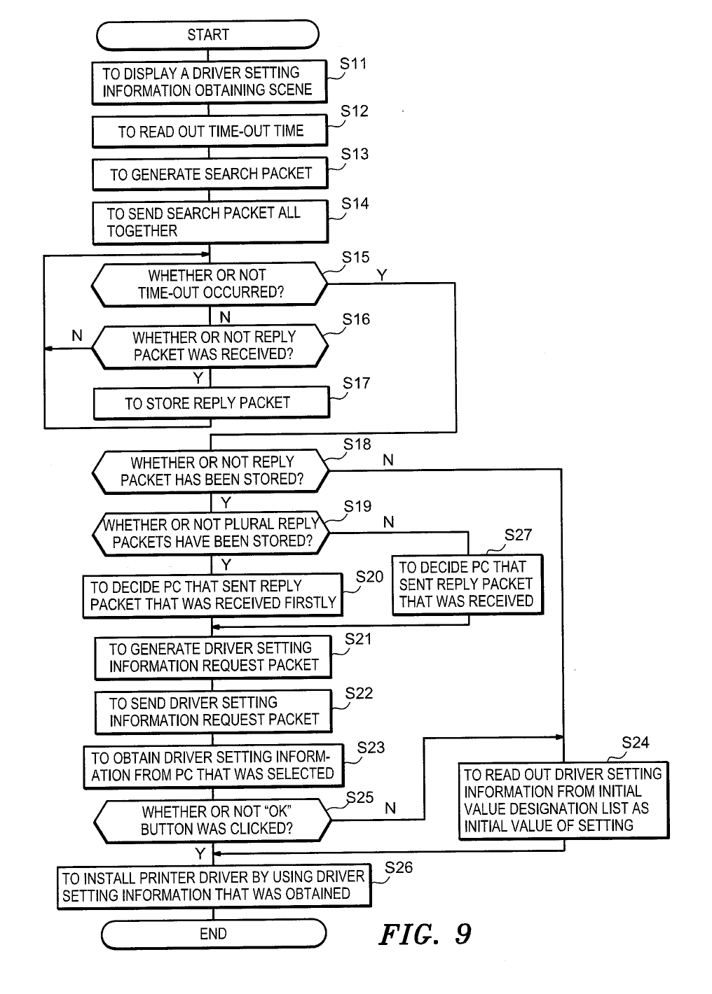

FIG. 9 is a flow chart for explaining operation of PC that inputs driver setting information in printing system of embodiment 1.

When the driver installer 1015 of the PC 10 is executed by the CPU, the GUI display/input controlling section 105 makes the displaying section 102 display the driver setting information obtaining scene that is shown by FIG. 6 (Step S11). When the execution button that is displayed on the driver setting information obtaining scene, is clicked by user, the GUI display/input controlling section 105 detects that the execution button was clicked, and outputs a start request to the search packet generating section 106.

The search packet generating section 106, after the start request is inputted, reads out the search packet identification code, the product code of printer driver, the version of driver installer 1015 and the time-out period from the search packet generation use table 1011 that is contained in the storing section 101, and stores the time-out period in the RAM (Step S12). Next, the search packet generating section 106, for generating search packet that is shown by FIG. 4A, as shown by FIG. 5, records header information in the header information item of the IP packet header part; furthermore, as shown by FIG. 4A, records header information such as version number, header length displaying, service type and IP packet length and the like that becomes necessary in the case to perform communication mutually in the network layer that is applied in OSI, in the header information item of the IP packet header part; records the IP address that is allotted to self-apparatus in the sending source IP address item; furthermore, records broadcast address in the sending destination IP address item.

Then, the search packet generating section 106 records the search packet identification code that was read out in the search packet identification code item of the data section; next, records the product code of the printer driver that was read out in the product code item; furthermore, records the version of the driver installer 1015 that was read out in the version item; and generates search packet (Step S13); and then outputs the search packet to the sending and receiving section 104. Next, the search packet generating section 106 reads out the time-out period that is stored in the RAM, and sets the time-out period in the timer, to start the measure.

The sending and receiving section 104, after the search packet is inputted from the search packet generating section 106, broadcasts the search packet in the LAN 50 (Step S14).

On the one hand, the reply packet detecting section 107, after the start request is inputted from the search packet generating section 106, judges that the timer is time-out (Step S15). The reply packet detecting section 107, when it is judged that the timer is time-out (Step S15), after outputted the start request to the reference destination PC selecting section 108, makes the Step S18 shift the processing. On the other hand, the reply packet detecting section 107, when it is judged that the timer is not time-out (Step S15; N), judges whether or not the reply packet that is shown by FIG. 4B is received (Step S16).

On the one hand, the reply packet detecting section 107, when it is judged that the reply packet has not been received (when it is judged that the reply packet identification code has not been recorded in the first 4 Byte in the data section of the IP packet that was received) (Step S16; N), makes the Step S15 shift the processing to continue the same processing as stated above. On the other hand, the reply packet detecting section 107, when it is judged that the reply packet has been received (Step S16; Y), stores the reply packet that was received in the reply packet buffer 1012 that is included in the storing section 101 (Step S17), and makes the Step S15 shift the processing to continue the same processing as stated above.

On the one hand, the reference destination PC selecting section 108, after the start request is inputted, judges whether or not the reply packet has been stored in the reply packet buffer 1012 (Step S18). When the reference destination PC selecting section 108 judges that the reply packet has not been stored in the reply packet buffer 1012 (Step S18; N), the driver setting information obtaining section 110 reads out driver setting information as initial value of the driver setting from the initial value information designation list 1014 that is stored in the storing section 101, makes the RAM store the driver setting information, and goes to Step S25 (Step S24).

On the other hand, the reference destination PC selecting section 108, when it is judged that the reply packet has been stored in the reply packet buffer 1012 (Step S18; Y), furthermore, judges whether or not plural reply packets have been stored in the reply packet buffer 1012 (Step S19).

The reference destination PC selecting section 108, when it is judged that plural reply packets have been stored in the reply packet buffer 1012 (Step S19; Y), decides that an IP address that is recorded in the sending source IP address item that is recorded in the reply packets that are stored in the firstly received reply packet, that is, in the place that the address of the reply packet buffer 1012 is the smallest as an IP address of the PC 20 that requests the driver setting information (Step S20). Next, the reference destination PC selecting section 108 reads out the IP address from the reply packets, and stores it in the RAM. Then, the reference destination PC selecting section 108 outputs the start request to the driver setting information request packet generating section 109.

The driver setting information request packet generating section 109, after the start request is inputted, reads out the IP address that is stored in the RAM. Next, the driver setting information request packet generating section 109, after the sending source IP address that is allotted to the self apparatus, and the sending destination address that is allotted to the PC 20 that requests the sending of the driver setting information generate the driver setting information request packet that is recorded (Step S21), outputs the setting information request packet to the sending and receiving section 104.

The sending and receiving section 104, after the setting information request packet stated above is inputted from the driver setting information request packet generating section 109, sends the driver setting information request packet to the PC 20 through the LAN 50 (Step S22).

Then, the sending and receiving section 104, after the driver setting information is received from the PC 20 that sent the driver setting information request packet, stores the driver setting information in the RAM (Step S23).

Then, the driver setting information display data generating section 111 reads out the driver setting information that is stored in the RAM, generates display data to display the driver setting information displaying scene shown by FIG. 7, and outputs the display data to the GUI display/input controlling section 105.

The display/input controlling section 105, after the display data stated above is inputted from the driver setting information display data generating section 111, makes the displaying section 102 display the driver setting information displaying scene.

Then, after the “OK” button that is displayed on the driver setting information displaying scene, is clicked by user, the display/input controlling section 105 outputs the execution information representing that the “OK” button was clicked to the driver installing section 112. On the other land, after the “cancel” button is clicked, the display/input controlling section 105 goes to Step S24 (Step S25).

The driver installing section 112 reads out the driver setting information from the RAM, on the basis of the driver setting information, the IP address of the printer 30 that is stored in the RAM and the version information that is inputted by user and that is stored in the RAM and the like, installs the printer driver that is stored in CD-ROM to execute the printing in the printer 30 (Step S26), and then is made to complete the processing.

In the Step S19, the reference destination PC selecting section 108, when it is judged that only one reply packet that was sent from the PCs 20 of # 1˜# n has been stored in the reply packet buffer 1012 (Step S19; N), decides that an IP address that is recorded in the sending source IP address item of the reply packet as an IP address of the PC 20 referring to the driver setting information (Step S27). Then, the reference destination PC selecting section 108 reads out the IP address from the reply packet, stores it in the RAM, makes the Step S21 shift the processing, and is made to perform the same processing as stated above.

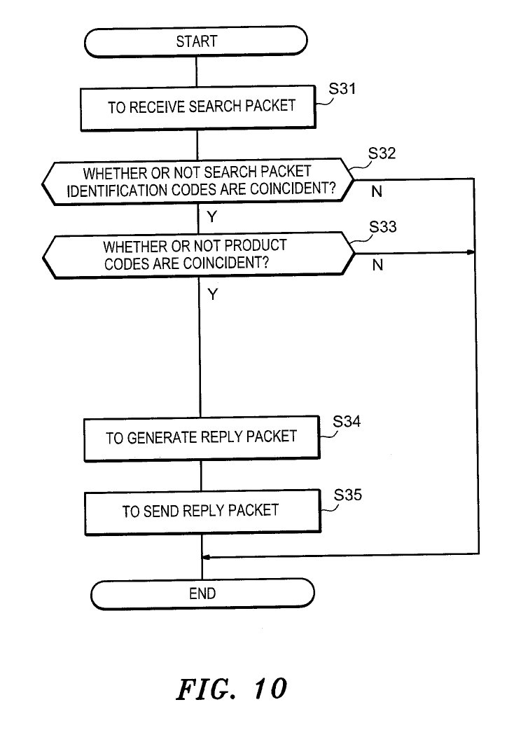

FIG. 10 is a flow chart for explaining operation of PC that sends driver setting information through FTP in printing system of embodiment 1. The driver setting information supplying section 202 of the PC 20 that sends the driver setting information in the FTP (according to FIG. 8), after the search packet is received from the PC 10 through the LAN 50 (Step S31), judges whether or not the search packet identification code that is recorded in the search packet identification code item coincides with the search packet identification code that is stored in the search packet detection use table 203 (Step S32).

On the one hand, the driver setting information supplying section 202, when it is judged that they are not consistent (Step S33; N), is made to complete the processing. On the other hand, the driver setting information supplying section 202, when it is judged that they are consistent (Step S33; Y), goes to Step S34.

Then, the driver setting information supplying section 202, as shown by FIG. 5, records header information such as version number, header length displaying, service type and IP packet length and the like that becomes necessary in the case to perform communication mutually in the network layer that is applied in OSI, in the header information item of the IP packet header part; records the IP address that is allotted to self-apparatus in the sending source IP address item; furthermore, records the IP address of the PC 10 in the sending destination IP address item.

Then, the driver setting information supplying section 202 records the reply packet identification code that was read out in the reply packet identification code item of the data section, next, records the product code of the printer driver that was read out in the product code item, furthermore, records the version of the printer driver that was read out in the version item, generates the reply packet that is shown by FIG. 4B (Step S34), sends the reply packet to the PC 10 (Step S35), and then completes the processing.

Moreover, as a transformation example in the generation of reply packet of the present embodiment, there is no problem even if there is a structure that shifts to the Step S34 of the generation of the reply packet by passing the Step that compares the version of the printer driver that should be installed, and judges whether or not it coincides with the version that is stored in the search packet detection use table 203.

According to the embodiment 1, it is possible to simultaneously send the search packet that is generated by the search packet generating section 106 to network 50, to select the PC 20 that installs the printer driver, then, to obtain the driver setting information from the PC 20 that received the driver setting information request packet that was generated by the driver setting information request packet generating section 109. Then, because the driver installing section 112 installs the printer driver through using the received driver setting information, so it is possible to shorten the time requesting in installing of the printer driver without inputting operation of the driver setting information.

### Embodiment 2

In the embodiment 2, in the case that plural printers that are different in setting, plural PCs in which printer drivers of those printers have been installed and a PC in which printer driver has not been installed, are connected in the LAN, and a printer driver is installed in the PC in which the printer driver has not been installed, a PC in which a desirable printer driver has been selected to obtain the printer driver from the PC.

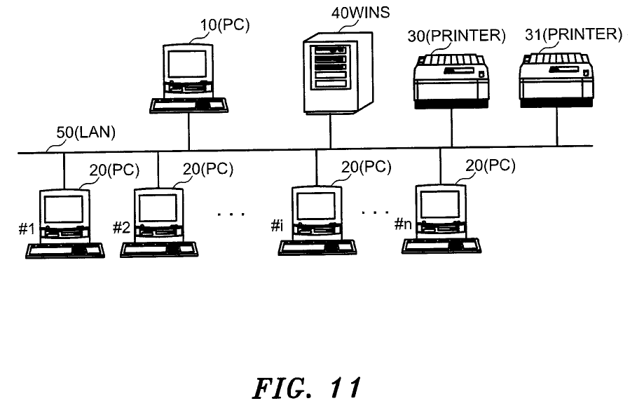

FIG. 11 is a block diagram showing a structure of a printing system in embodiment 2. As shown by FIG. 11, in the print system, a PC 10, PCs 20 of # 1˜# n, a printer 30, 31 and a WINS (Window Nt Server) 40 have been connected through a LAN 50.

The PC 10 is a PC in which the printer driver has not been installed.

The PCs 20 of # 1˜# n are PCs in which a printer driver of printer 30 or printer 31 has been installed.

The printer 30, 31 are the printers of the same type of machine, but are different in driver setting information (IP address, existence/inexistence of duplex print unit, existence/inexistence of second tray, resolution, toner save “ON/OFF”, print quality, color/monochrome and the like).

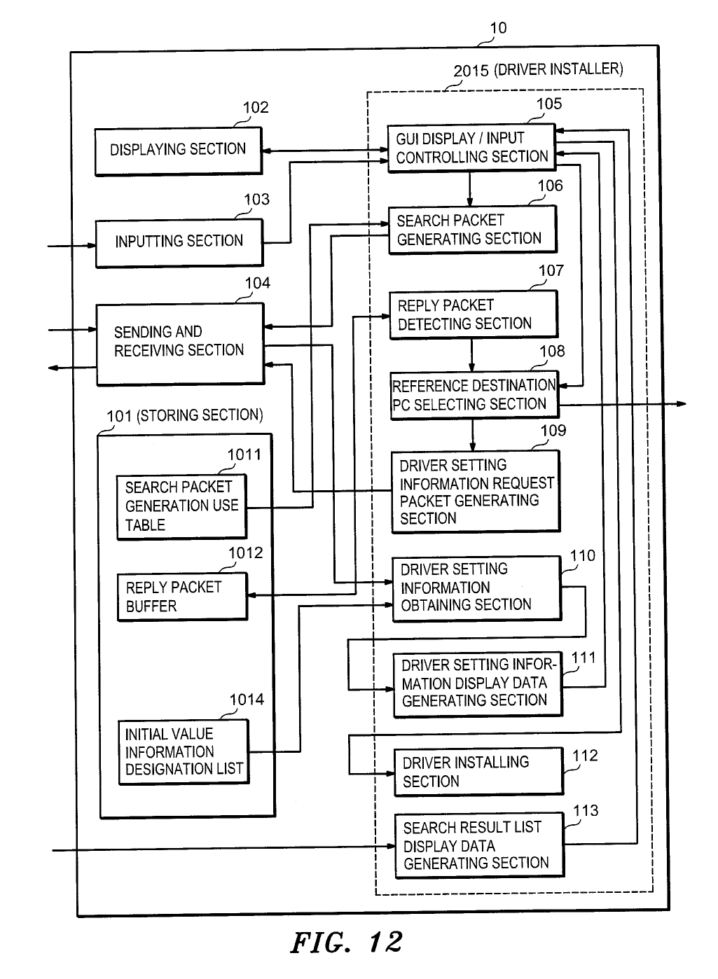

FIG. 12 is a block diagram showing a structure of a PC in a printing system to install a printer driver and showing a structure of a driver installer 2015 that was expanded in the PC, in embodiment 2.

The PC 10 and the driver installer 2015, as shown by FIG. 12, comprises a storing section 101, a displaying section 102, an inputting section 103, a sending and receiving section 104, a GUI display/input controlling section 105, a search packet generating section 106, a reply packet detecting section 107, a reference destination PC selecting section 108, a driver setting information request packet generating section 109, a driver setting information display data generating section 111, a driver install 112 and a search result list display data generating section 113. Here, respective inputting section 103, sending and receiving section 104, GUI display/input controlling section 105, search packet generating section 106, reply packet detecting section 107, reference destination PC selecting section 108, driver setting information request packet generating section 109, driver setting information display data generating section 111 and driver install 112 are the same as that of the embodiment 1.

The storing section 101 of first of information use is formed from RAM, ROM, flash memory and hard disc apparatus (not shown) the same as that of the embodiment 1, has a search packet generation use table 1011 and a reply packet buffer 1012, and stores an initial value designation list 1014 and a control program (not shown). Furthermore, display data is stored to display search result list displaying scene in the RAM generating the storing section 101.

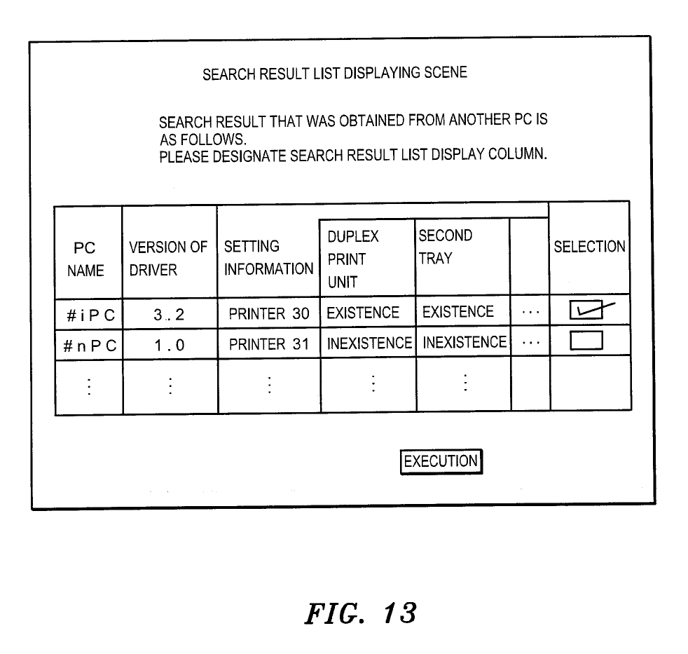

The displaying section 102 displays search result list displaying scene shown by FIG. 13. The search result list displaying scene, as shown by FIG. 13, displays a PC name that is Net BIOS name designating the PC 20 that sent the reply packet, a check result display column to display with respect to the version of the printer driver that has been installed in the PC 20 and setting information, a selection check box for selecting check result display column and a “execution” button.

The search result list display data generating section 113, after the PC name with respect to all the IP address from the WINS 40 is inputted, generates display data of the search result list displaying scene.

In the PCs 20 of # 1˜# n of FIG. 11, the printer driver of the printer 30 or the printer 31 has been installed.

Here, it is to explain a structure of a printer driver of embodiment 2.

FIG. 16 is a block diagram showing a structure of # iPC and # nPC in which printer driver is installed.

The structure of the printer driver is the same as # iPC and # nPC, and is composed of driver setting information 202, driver setting information storing table and search packet detection use table 203. In the embodiment 2, there is difference in the driver setting information storing table that has been installed in the # iPC 20 and # nPC 20. As shown on the search result list displaying scene of FIG. 13, because the driver setting information of the printer 30 has been installed in the # iPC 20; and the driver setting information of the printer 31 has been installed in the # nPC 20, the # iPC 20 has a driver setting information storing table 201, and the # nPC 20 a driver setting information storing table 301.

The WINS 40 of FIG. 11 decides an IP address that was allotted to the PC 20 that was designated by the PC name. Further, the WINS 40 checks the PC name that designates an name of the PC 20 from the IP address that was inputted from the reference destination PC selecting section 108, and outputs the checked PC name to the search result list display data generating section 113.

Next, it is to explain operation of a printing system of embodiment 2 in the present invention.

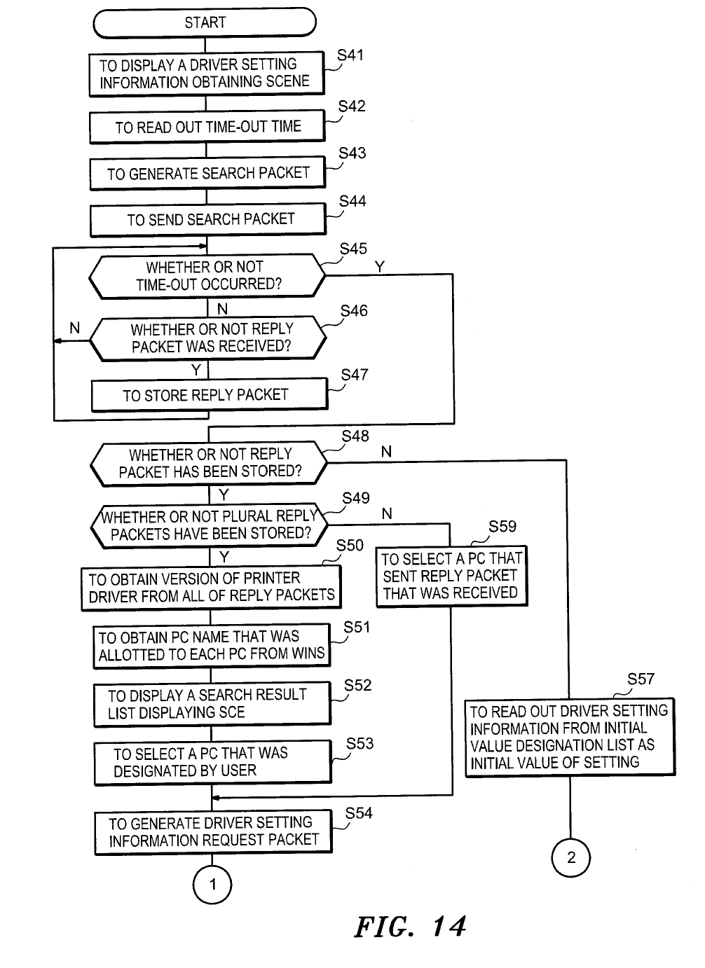

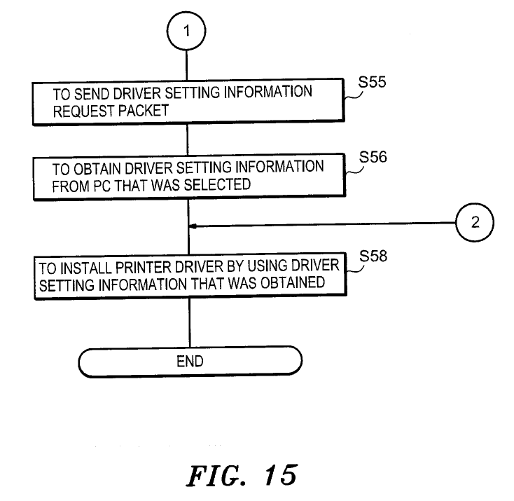

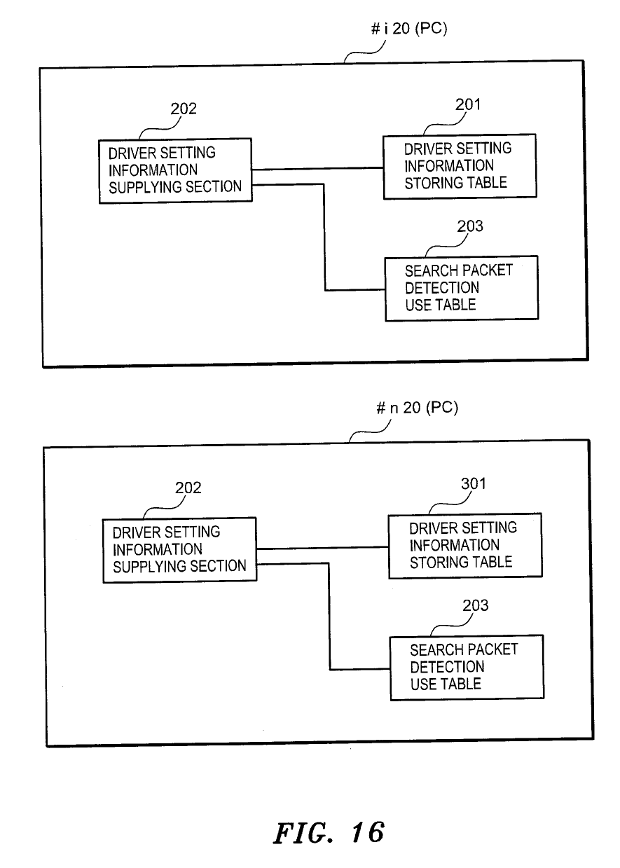

FIG. 14 and FIG. 15 are flow charts for explaining operation of PC 10 that inputs driver setting information in printing system of embodiment 2. Processes from the Step S41 in which, after the driver installer 2015 of the PC 10 was executed, the GUI display/input controlling section 105 makes the displaying section 102 display the driver setting information obtaining scene shown by FIG. 6, to the Step S49 in which the reference destination PC selecting section 108 judges that the reply packet has been stored in the reply packet buffer 1012, furthermore, and judges whether or not plural reply packets have been stored, are the same as the processes from Step Si to Step S19 of embodiment 1. However, in the present embodiment, in order to collect plural printer setting information such as the printer 30 and the printer 31, the search packet with respect to the printer 30, and the search packet with respect to the printer 31 are respectively generated and sent.

On the one hand, in the Step S49, the reference destination PC selecting section 108, in the case to judge that only one reply packet has been stored in the reply packet buffer 1012 (Step S49; N), decides that the IP address that has been recorded in the sending source address item of the reply packet is the IP address of the PC 20 referring to the driver setting information (Step S59), and shifts the process to Step S54.

On the other hand, the reference destination PC selecting section 108, in the case to judge that plural reply packets have been stored in the reply packet buffer 1012 (Step S49; Y), reads out the reply packets in order from the reply packet buffer 1012, reads out version of the printer driver that has been recorded in the version item of the reply packet, and stores them in the RAM with respect to the version that was read out and the IP address that was allotted to the PC that sent the reply packet. Like this, the reference destination PC selecting section 108, after read out the version that has been recorded in all the reply packets that have been stored in the reply packet buffer 1012, and stored it in the RAM with respect to the IP address that sent the reply packet (Step S50), outputs all the IP addresses that have been stored in the RAM in the WINS 40 in order.

The WINS 40, after IP addresses are inputted in order from the reference destination PC selecting section 108, checks the PC name designating the name of the PC 20 from the inputted IP addresses, and outputs the checked PC name to the search result list display data generating section 113.

The search result list display data generating section 113, after the PC name is inputted from the WINS 40 with respect to all the IP addresses, generates display data to display search result list displaying scene that is shown by FIG. 13 and displayed on the displaying section 102. Then, the search result list display data generating section 113 outputs the display data to the GUI display/input controlling section 105.

The GUI display/input controlling section 105 makes the displaying section 102 display the search result list displaying scene shown by FIG. 13 on the basis of the display data stated above that was inputted from the search result list display data generating section 113 (Step S52).

Then, after user designates one PC name from the PC names that have been displayed on the search result list displaying scene shown by FIG. 13, and clicks the execution button, the GUI display/input controlling section 105 outputs the PC name that was designated by user to the reference destination PC selecting section 108.

The reference destination PC selecting section 108 decides the PC 20 of the PC name that was inputted from the GUI display/input controlling section 105 and the PC name of the PC 20 referring to the driver setting information (Step S53). Then, the reference destination PC selecting section 108 outputs a drive request in the driver setting information request packet generating section 109.

Moreover, in the present embodiment, it is a structure that selects one PC name from PC names that have been displayed on the search result list scene. However, the same as embodiment 1, because a “cancel” button is arranged in the search result list scene, and the “cancel” button is clicked, so it may also be a structure that shifting to Step S57, and using the driver setting information that has been stored in the initial value information designation list 1014.

Then, in the Step S58 from the Step S54, the process in which the driver installing section 112 installs the printer driver is the same as the process from the Step S21 to Step S25 in embodiment 1.

According to embodiment 2, because user can install the printer driver containing a setting of the printer using the PC from the designated PC, usually, the labor to confirm and input the driver setting information such as the IP address that must be set in the case to install the printer driver, the existence/inexistence of duplex print unit, the existence/inexistence of second tray, the resolution, the toner save “ON/OFF”, the print quality, the color/monochrome and the like is saved.

Moreover, according to embodiment 2, there is a structure that can use driver setting information of the PC that was designated by user. Further, in the embodiment 1 and embodiment 2, there is a structure that uses all driver setting information of a specified PC. However, even if the most part of setting information may also be the driver setting information of the specified PC, it is also considered in the case to request a setting of driver through a structure in which a part of function uses initial setting information.

Thereby, for example, as shown by FIG. 17, with respect to the driver setting information of the specified PC, it may also be made to display initial setting information, and to select the specified driver setting information only according to information obtained by inputting check to the column of “application of setting information of other PC”.

Here, it is to explain an example as a transformation example of embodiment 2.

FIG. 17 is a diagram showing an example of the driver setting information displaying scene of a transformation example corresponding to the FIG. 7 of embodiment 1. In the present embodiment, with respect to information of the specified PC, in order to apply resolution of initial value “600 dpi” to an item of resolution, a check does not need to input to the column “application of setting information of other PC”. However, in order to apply driver setting information of the specified PC to other setting item, a check is inputted to the column of “application of setting information of other PC”.

In the case, for example, after applied the driver setting information of the predetermined PC, it is possible to only read out setting value from the initial value information designation list 1014 to correspond to item whose column of “application of setting information of other PC” is not be checked, so as to only apply the initial information of un-checked item.

Because of such a structure, it is possible to set a setting requested by driver install worker while installing driver.

### THE UTILIZATION POSSIBILITY ON INDUSTRY

In embodiment 1 and embodiment 2, it explained the driver setting information about the printer as driver setting information. However, the present invention is not limited in the case, it can also be applied to driver setting information about other apparatus, for example, external apparatus to control operation by using PC, such as scanner and the like.

The present invention is not limited to the foregoing embodiments but many modifications and variations are possible within the spirit and scope of the appended claims of the invention.

What is claimed is:

1. A printing system, comprising:
a first image processing apparatus that includes an installer for installing a driver to drive an image forming apparatus, and installs the driver; and
a second image processing apparatus in which the driver is incorporated,
wherein the first image processing apparatus is connected with the second image processing apparatus through network,
the installer that is included in the first image processing apparatus, has:
a search request section that outputs a search request representing whether or not the driver has been installed to the second processing apparatus through the network;
a driver setting information obtaining section that, after received a reply information from the second image processing apparatus with respect to the search request, outputs a sending request of the driver setting information with respect to the second image processing apparatus; and
an installing section that installs the driver on the basis of the driver setting information that was obtained from the driver setting information obtaining section,
wherein the second image processing apparatus includes:
a first sending section that generates and sends reply information to reply to search request of the search request section; and
a second sending section that generates and sends driver setting information to reply to send request of the driver setting information obtaining section.

2. The printing system according to claim 1,
wherein the first image processing apparatus further includes an initial value information storing section that stores initial value information in which initial value of the driver setting information is recorded,
the installing section installs the driver according to the initial value information in the case that the driver setting information obtaining section can not receive the reply information.

3. The printing system according to claim 1,
wherein the installing section installs the driver from the second image processing apparatus of delivery source when the driver setting information obtaining section received reply information firstly.

4. The printing system according to claim 1, further comprising:
a displaying section that displays information,
wherein the driver setting information obtaining section, when plural reply information are received, generates list information of the plural reply information and select the second image processing apparatus that sets delivery source from the list information displayed on the displaying section.

5. The printing system according to claim 1, further comprising:
a displaying section that displays information,
wherein the driver setting information obtaining section, when the reply information is received, displays information of the reply information and the initial value information on the displaying section, so as to select setting information for installing.

6. An information processing system, comprising:
a first information processing apparatus that includes an installer for installing a driver to operate an external apparatus, and installs the driver; and
a second information processing apparatus in which the driver is incorporated,
wherein the first information processing apparatus is connected with the second information processing apparatus through network,
the installer that is included in the first information processing apparatus, has:
a search request section that outputs a search request representing whether or not the driver has been installed to the second information processing apparatus through the network;
a driver setting information obtaining section that, after received a reply information from the second information processing apparatus with respect to the search request, outputs a sending request of the driver setting information with respect to the second information processing apparatus; and
an installing section that installs the driver on the basis of the driver setting information that was obtained by the driver setting information obtaining section,
wherein the second information processing apparatus includes:
a first sending section that generates and sends reply information to reply to search request of the search request section; and
a second sending section that generates and sends driver setting information to reply to send request of the driver setting information obtaining section.

7. The information processing system according to claim 6,
wherein the external apparatus is an image forming apparatus for forming image.

8. The information processing system according to claim 7,
wherein the first and second information processing apparatuses are first and second image processing apparatuses to process image.

9. The information processing system according to claim 6,
wherein the first information processing apparatus further includes an initial value information storing section that stores initial value information in which initial value of the driver setting information is recorded,
the installing section installs the driver according to the initial value information in the case that the driver setting information obtaining section can not receive the reply information.

10. The information processing system according to claim 9,
wherein the installing section installs the driver from the second information processing apparatus of delivery source when the driver setting information obtaining section received reply information firstly.

11. The information processing system according to claim 6, further comprising:
a displaying section that displays information,
wherein the driver setting information obtaining section, when plural reply information are received, generates list information of the plural reply information and select the second information processing apparatus that sets delivery source from the list information displayed on the displaying section.

12. The information processing system according to claim 6, further comprising:
a displaying section that displays information,
wherein the driver setting information obtaining section, when the reply information is received, displays information of the reply information and the initial value information on the displaying section, so as to select setting information for installing.
